(19) United States
(12) Patent Application Publication
(10) Pub. No.: US 2008/0052912 A1
(43) Pub. Date: Mar. 6, 2008

(54) Integrated shave counter and base

(75) Inventors: Kevin S. Barry, Fairfield, CT (US); Dave Ross, Orange, CT (US)

Correspondence Address: Michaud-Duffy Group LLP, Suite 206, 306 Industrial Park Road, Middletown, CT, 06457, US

(73) Assignee: Eveready Battery Company. Inc., St. Louis, MO (US)

(21) Appl. No.: 11/897,060

(22) Filed: Aug. 28, 2007

Related U.S. Application Data
(60) Provisional application No. 60/841,692, filed on Sep. 1, 2006.

(51) Int. Cl. B26B 21/40; A45D 27/00

(52) U.S. Cl. 30/41.7; 30/537; 30/541

(57) ABSTRACT

In a wet shave razor integrated with a base unit, the razor has a handle, at least one razor cartridge coupled to the handle, a control module and a sensor integrated into the handle, a sensor for detecting movement of the handle, and memory for storing data related to the movement of the handle. The base unit has a display for indicating data pertaining to cartridge use, a controller in communication with the display, and a mechanism for transferring data from the memory to the controller when the razor is received by the base unit. A method of tracking the use of shaving devices includes receiving an input signal indicative of a movement of the shaving device, maintaining a count of a number of the input signals, incrementing the count in response to additional received input signals, and displaying a value in response to the counted number of input signals.

### CROSS REFERENCE TO RELATED APPLICATION

This application claims the benefit of Provisional Patent application Ser. No. 60/841,692, filed Sep. 1, 2006.

### TECHNICAL FIELD

This invention relates generally to shaving implements and, more particularly, to a wet shaving system in which usage of a razor cartridge is monitored and information concerning such usage is conveyed to a user.

### BACKGROUND OF THE INVENTION

Modern wet shave razors generally employ a disposable razor cartridge. As the blades housed within the razor cartridges become dull from repeated use, the quality of subsequent shaving experiences deteriorates. Eventually, shave quality deteriorates to a point where the cartridge must be replaced. A difficulty occurs in that users often do not monitor or remember how many times a particular razor cartridge has been used. As such when it is time to change a cartridge the user may not have one on hand, thereby forcing the user to potentially endure an uncomfortable shave until such time as a replacement razor cartridge can be obtained.

Hair differs with regard to hardness, with harder hair being more difficult to cut. The hardness of hair is determined by the amount of keratin in the hair. Keratin is a natural fibrous protein that is made up of several different amino acids. The proportions of these amino acids that make up the keratin vary between people, thereby resulting in the differences in hair hardness. These differences in hair hardness in turn result in differing wear rates for a wet shave razor cartridge. Accordingly, depending on the characteristics of a users hair, the useful life expectancy of a razor cartridge will vary from user to user. Since razor cartridges also differ (i.e., some are higher quality than others, and some have more blades that others) it is sometimes difficult for a user to determine how many shaves can be comfortably obtained from a particular type of razor cartridge. This problem is further exacerbated by the fact that different users shave differently. Some many use more strokes than others, and some may use longer or shorter strokes than others. These factors each affect the useful life of a razor cartridge. Accordingly, there is a current need for a way by which a user can determine and monitor the useful life of a razor cartridge.

Based on the foregoing, it is a general object of the present invention to provide a shaving device that provides a user with feedback regarding the quality of a razor cartridge over time.

### SUMMARY OF THE INVENTION

According to one aspect, the present invention is directed to shaving systems comprising shaving units integrated with base units. In one embodiment, the shaving system is a wet shave razor integrated with a base unit. The wet shave razor has a handle, at least one razor cartridge coupled to the handle, a control module integrated into the handle and including a sensor for detecting movement of the handle, and a memory means for storing data related to the movement of the handle. The base unit, which is adapted to removably and integratably receive at least a portion of the wet shave razor, has a display for indicating data pertaining to razor cartridge use, a controller in communication with the display for sending data to the display, and transfer means for transferring data from the memory means to the controller when at least a portion of the wet shave razor is received by the base unit. The storing, displaying, and transferring of data is effected via at least one software algorithm. Data displayed on the display function may be the number of shaving strokes taken, the number of shaving strokes left until the razor blade(s) should be replaced, the time, or any combination thereof.

In another aspect, the present invention is directed to methods of tracking the use of shaving devices. In one embodiment, the method comprises the steps of receiving an input signal indicative of a movement of the shaving device, maintaining a count of a number of the input signals, incrementing the count in response to additional received input signals, and displaying a value in response to the counted number of input signals. One type of signal indicative of the movement of the shaving device may be a signal from a switch that operates in response to a tilting motion of the shaving device.

One advantage of the present invention is that a user can be put on notice that the razor blades of a shaving implement need to be replaced. The user is periodically reminded of the limited life of the razor blades. Accordingly, the user can change the razor blades before they degrade to the point at which nicks or cuts are inflicted. Thus, the demise of the razor blades can be anticipated, and new razor blades can be purchased in advance of the actual need.

### BRIEF DESCRIPTION OF THE DRAWINGS

FIG. 1 is a perspective view of the wet shaving system of the present invention having a shaving unit and an integrated base.

FIG. 2 is a side cutaway view of a razor head of the shaving unit of the present invention.

FIG. 3 is a perspective view of a replaceable cartridge of a razor head.

FIG. 4 is a side cutaway view of the shaving unit of the present invention.

FIG. 5 is a schematic representation of an electronic control module in the shaving unit.

FIG. 6 is a side cutaway view of the base of the present invention.

FIG. 7 is a schematic representation of the display unit of the base.

FIG. 8 is a side cutaway view of the shaving unit inserted in the base.

### DETAILED DESCRIPTION OF THE PREFERRED EMBODIMENTS

Disclosed herein are wet shaving systems and methods of their use. As used herein, wet shaving systems are those in which a shaving device is used in conjunction with an aqueous composition or in an aqueous environment to facilitate the removal of hair from a hirsute surface. Typically, the shaving devices employed are flexible razor blades having sharpened edges. Other shaving devices, e.g., microprismatic elements that can be used to cut hair, are also within the scope of this disclosure.

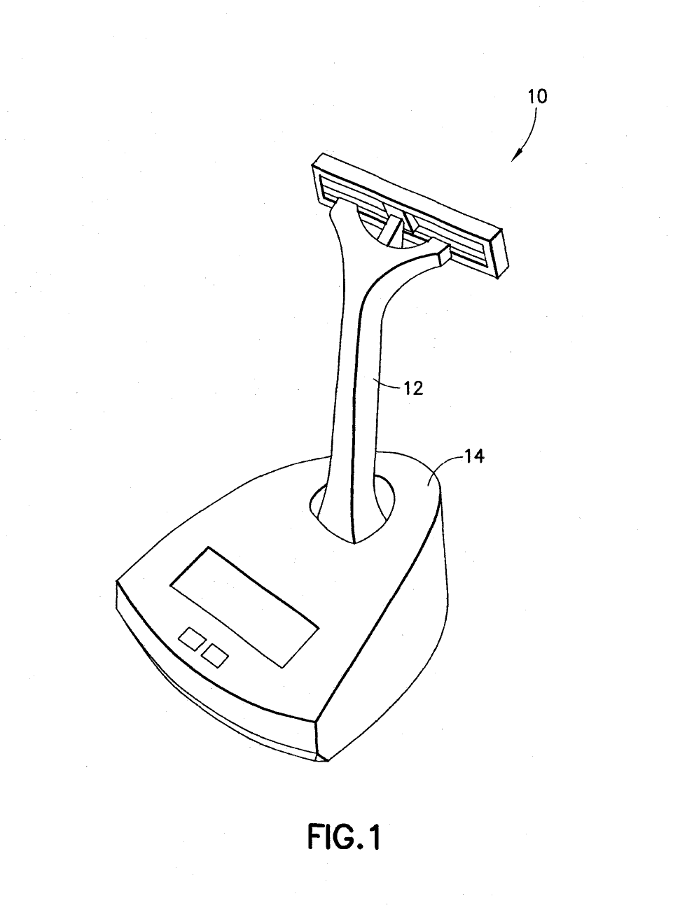

Referring to FIG. 1, a wet shaving system of the present invention is shown generally at 10 and is hereinafter referred to as “system 10.” The system 10 is defined by two integrated components, namely a shaving unit 12 (e.g., a wet shave razor) and a base 14. Between uses, the shaving unit 12 is stored in the base 14 where the shaving unit is charged and recharged in preparation for subsequent uses. Charging and recharging is effected via an inductive coupling link maintained between the shaving unit 12 and the associated base 14. Data is also transmitted from the shaving unit 12 to the base 14 via the inductive coupling link. One type of data that may be transmitted is a count of the number of shaving strokes.

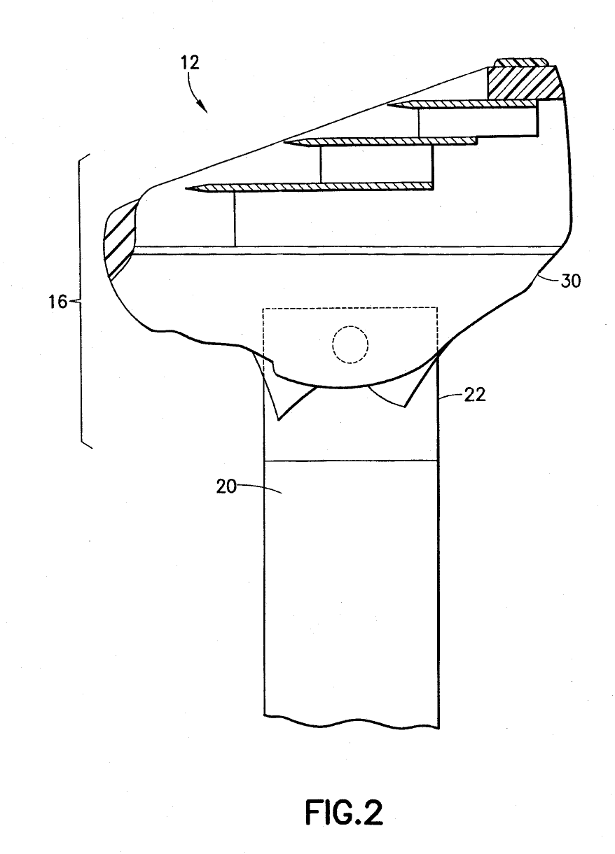

Referring now to FIG. 2, the shaving unit 12 comprises a razor head 16 mounted on a handle 20. The razor head 16 comprises a pivot frame 22 that extends from the handle 20 such that a razor blade cartridge 30 (which may be replaceable) can be mounted on the pivot frame 22. The blade cartridge 30 can be mounted via the engagement of any suitable structure such as, for example, arcuate surfaces formed on the razor blade cartridge that engage corresponding arcuate surfaces on the pivot frame.

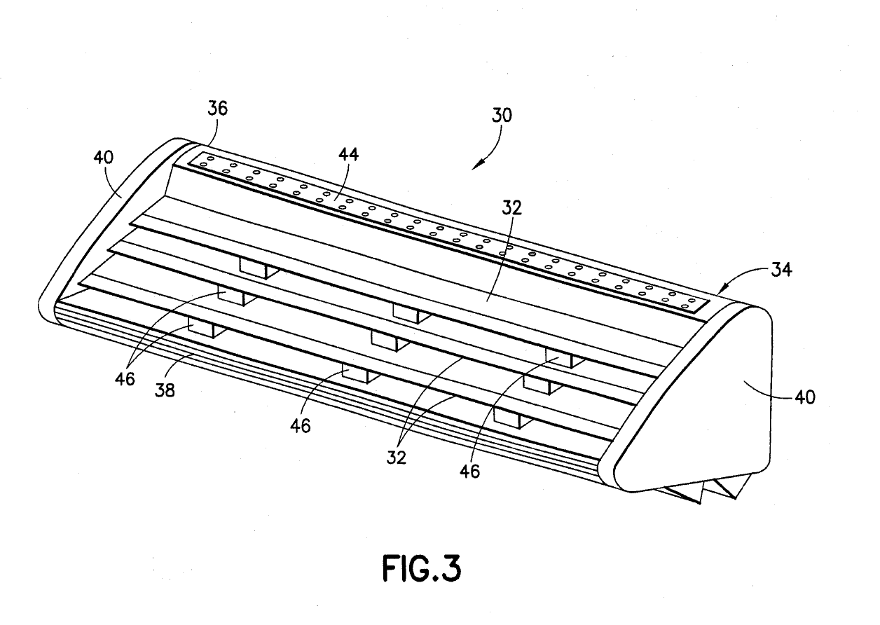

As shown in FIG. 3, the razor blade cartridge 30 has any number of razor blades 32 mounted thereon. Preferably, the razor blades 32 are fixedly mounted within a frame 34 or similar structure having a cap 36, a guard 38, and end walls 40. The cap 36 may further have a comfort strip 44 or other device attached thereto to provide cleanly-shaven skin with a medicament or other compound when the shaving unit is used. Spacers 46 are positioned between the razor blades 32 to assist in maintaining the proper spacing between the razor blades and to facilitate the wash-through of shaving debris during use. Arcuate surfaces formed on the underside of the frame 34 may be, for example, rocker bearings or the like to provide for the engagement of the razor blade cartridge 30 with the pivot frame and to facilitate pivotal movement of the razor blade cartridge with respect to the surface being shaved, thereby allowing the associated razor blades to be maneuvered over the surface and around obstacles to provide for optimum shaving results.

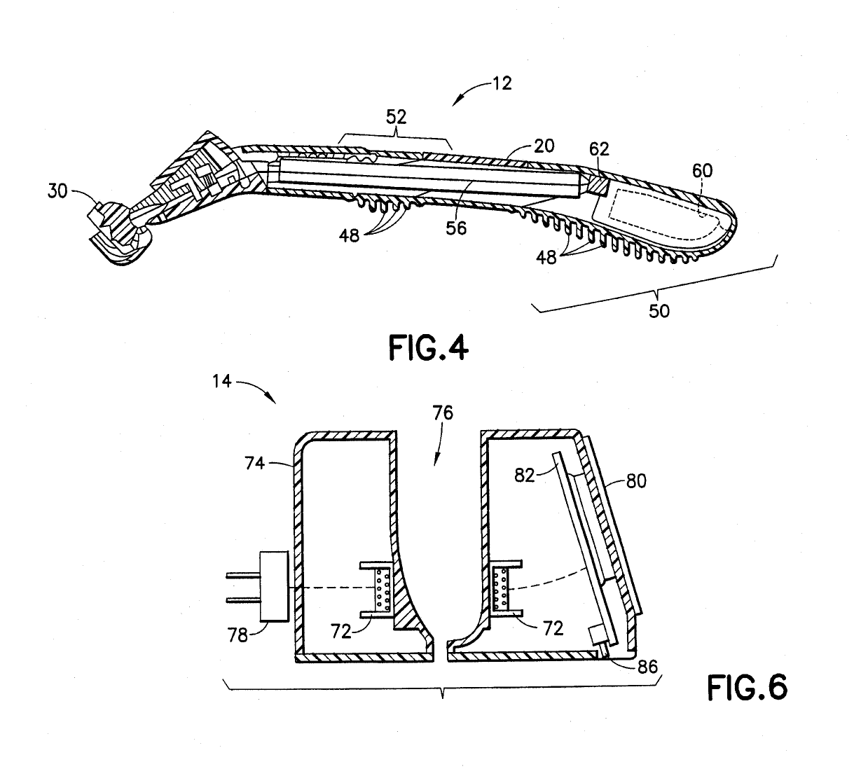

Referring to FIG. 4, the handle 20 of the shaving unit 12 comprises an elongated tubular member that is graspable by the user. The handle 20 may be ergonomically shaped or at least contoured in such a way so as to provide sufficient comfort during a shaving operation. Outer surfaces of the handle 20 may be covered with an elastomeric material configured to define ridges 48 that allow the user to positively grip the shaving unit. In one embodiment, a rearward portion 50 of the handle 20 has one arrangement of elastomeric ridges to be gripped by the user's third, fourth, and fifth fingers, while an intermediate portion 52 of the handle has another arrangement of elastomeric ridges to be gripped by the user's thumb and forefinger.

A release switch assembly 56 is mounted within the handle 20 and provides operable communication between the razor blade cartridge 30 and an electronic control module 60 in the rearward portion 50 of the handle. A forward portion of the release switch assembly 56 is releasably attached to the blade cartridge 30, and a rearward portion of the release switch assembly is attached to a magnet 62.

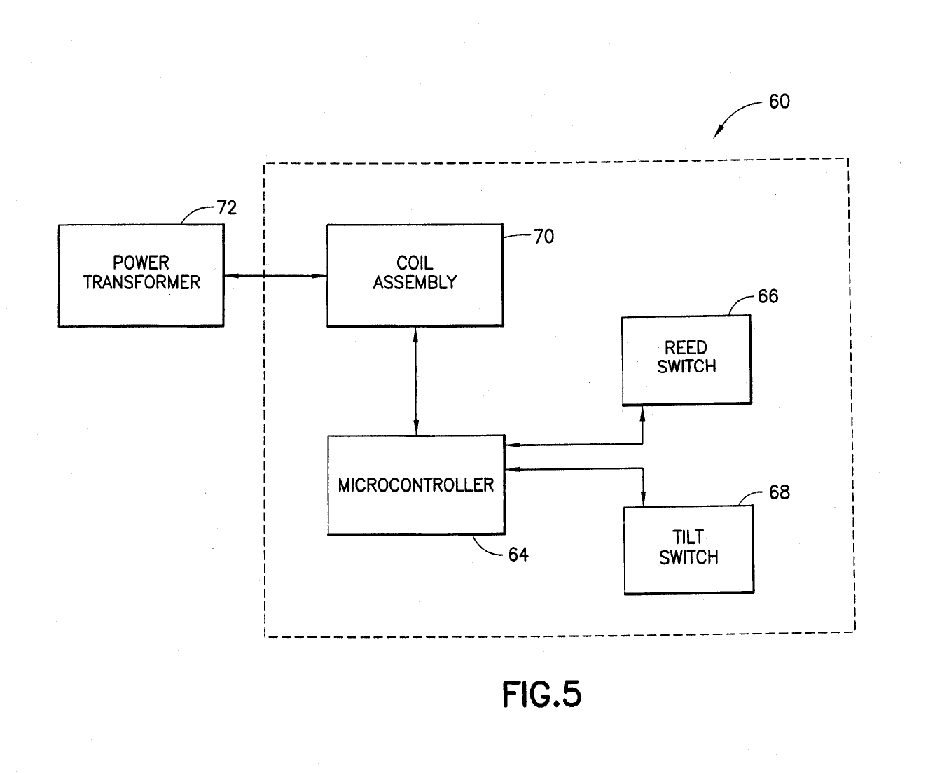

Referring now to FIG. 5, the electronic control module 60 comprises at least one sensor capable of detecting movement of the handle. The electronic control module 60 includes a microcontroller 64, a magnetic reed switch 66, a tilt switch 68, and a coil assembly 70. The microcontroller 64 is a printed circuit board (PCB) that is in communication with the magnetic reed switch 66, the tilt switch 68, and the coil assembly 70. Preferably, the microcontroller 64 includes a memory device for storing data related to the movement of the handle as well as a capacitance device that stores and provides power to the components of the PCB. A battery can also be used in lieu of the capacitance device to store and provide power. The entire electronic control module 60 is preferably potted in a waterproof compound and self-contained, thus eliminating the opportunity for liquid water or condensate to collect and adversely affect the circuitry of the microcontroller 64. Because the shaving unit operates via inductive coupling, there are no wires or other physical links that extend from the electronic control module 60. The reed switch 66 and the tilt switch 68 operate as sensors that detect movement of the handle.

The reed switch 66 comprises two reeds, at least one of which is magnetic, that are independently mounted and biased so as to be out of contact with each other when not in the presence of the magnetic field of the magnet of the release switch assembly. The tilt switch 68 is level device and may be a bubble in an encapsulated liquid, a flapper that is pivotably mounted and weighted to rotate so that one portion thereof is always in a particular orientation, or the like. In any embodiment of the tilt switch 68, a sensor reads the position of the switch and conveys a signal to the microcontroller 64 for processing (e.g., the number of changes from an upward vertical orientation to a level or downward vertical orientation (“tilts”)). The coil assembly 70 is a wrapping of wires that, when the shaving unit is inserted in the base, is in magnetic communication with a power transformer 72 in the base 14 to provide power to the microcontroller 64.

Referring now to both FIGS. 4 and 5, upon release of the razor blade cartridge 30 from the release switch assembly 56, the release switch assembly and the magnet 62 slide forward in the handle 20. Because when the magnet 62 slides forward away from the reed switch 66 the magnetic field is removed therefrom, the reeds are allowed to engage each other. Subsequent separation of the reeds, namely, by the insertion of another razor blade cartridge such that the magnet 62 slides rearward in the handle 20 to impose the magnetic field on the reed switch 66 thereby opening the reeds, registers in the microcontroller 64. In a preferred embodiment, the registration of a new magnetic field in the microcontroller 64 resets a shaving stroke counter embodied in software programmed into the microcontroller.

The software programmed into the microcontroller 64 executes an algorithm that receives input signals indicative of the movement of the shaving unit 12 from the switches and qualifies such movements. As used herein, the term “qualifies” means counts the number of strokes and records the count number in the electronic control module 60. The algorithm is based on the user's movements during a shaving operation. More specifically, the tilting down movement to rinse accumulated shaving debris from the razor blades and the movement back to the shaving position are recorded. The algorithm then accordingly increments the shave count.

Referring now to FIG. 6, the base 14 is adapted to removably and integratably receive at least a portion of the shaving unit. The base 14 comprises a housing 74 having a port 76 configured to accommodate the shaving unit. The power transformer 72 is located in the housing 74 to provide an inductive coupling link to the coil assembly in the handle of the shaving unit when the shaving unit is located in the port 76. An alternating current (AC) line 78 is connected to the power transformer 72, as is a display unit 80. A base microcontroller 82 in the form of a PCB is disposed in electronic communication with the power transformer 72 and the display unit 80. A software algorithm in the PCB provides a means of transferring data from the memory device of the microcontroller of the shaving unit to the base microcontroller 82. Preferably, the housing 74 is a unit molded from plastic or cast from metal that is capable of withstanding the typical conditions encountered in the wet shaving environment (e.g., temperature, humidity, and the like). Furthermore, the housing 74 is preferably weighted or capable of being fixed to a surface so as to avoid or at least minimize the opportunity for unintentionally upsetting the position of the shaving system.

When the shaving unit is returned to the port 76 after use, the data qualified by the software algorithm is transferred to the base microcontroller 82. The data, namely, an indicator of the number of shaving strokes taken or the number of shaving strokes remaining until replacement of the razor blades should be considered, is displayed on the display unit 80 for a period of time when the device is removed from or returned to the port 76. The indication of the shaving strokes may be displayed in any suitable manner such as digitally, using some type of written notation (e.g., shave/replace), or with gradations of color that indicate to the user the expected life of the razor blades.

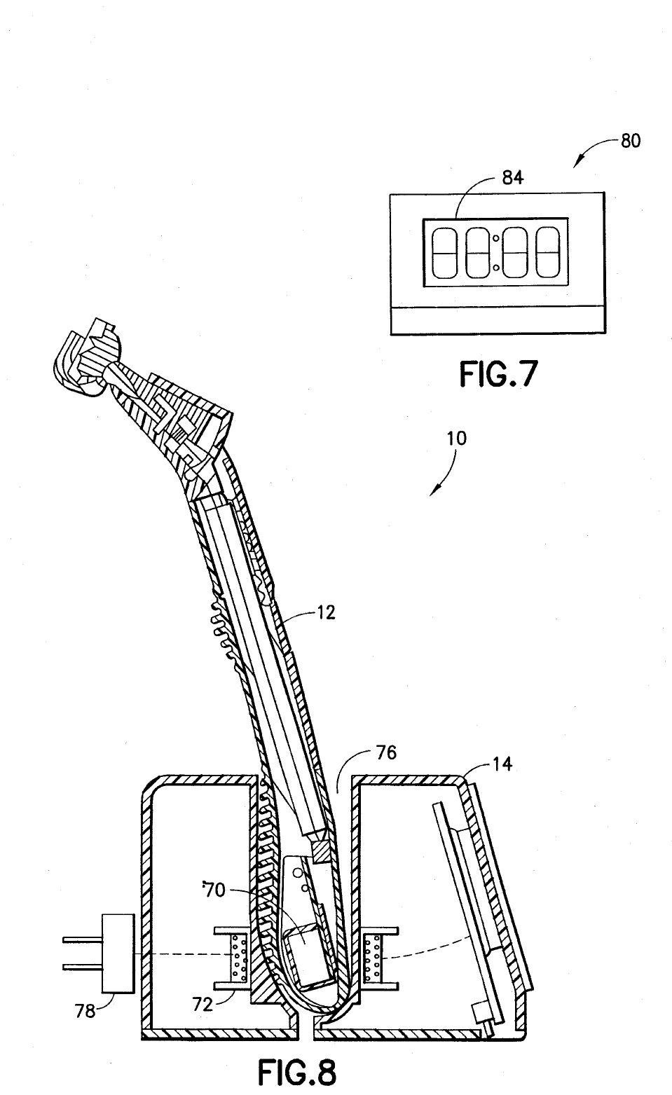

As is shown in FIGS. 6 and 7, the display unit 80 comprises a readout screen 84 that comprises a liquid crystal display (LCD). In the alternative, the screen 84 may comprise a light emitting diode (LED). When the shaving unit is removed from the base 14 for a shaving operation, the indicator of the number of shaving strokes at the culmination of the previous shaving operation is briefly displayed. When the shaving unit is returned to the base 14 after a shaving operation, an indication of the number of shaving strokes is briefly displayed. In either case, after briefly displaying the indicator, the time is displayed. The time may be set or adjusted using a clock set button 86 that is in communication with the base microcontroller 82.

Referring now to FIG. 8, when the shaving unit 12 is inserted into the port 76 of the base 14 and when the AC line 78 is connected to an AC power source, the coil assembly 70 is positioned proximate the power transformer 72 in the base. Magnetic communication between the coil assembly 70 and the power transformer 72 provide for the charging of the capacitance device of the microcontroller of the electronics control module in the shaving unit 12. Because of the use of inductive coupling, the system 10 is a low current device and can typically provide two shaves over a period of about twenty-six hours without the shaving unit 12 being returned to the base 14.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A shaving system, comprising:
a wet shave razor including,
a handle,
at least one razor cartridge coupled to said handle,
a control module integrated into said handle and including a sensor for detecting movement of said handle, and
memory means for storing data related to said movement; and
a base unit adapted to removably and integratably receive at least a portion of said wet shave razor, said base unit including,
a display for indicating data pertaining to razor cartridge use to a user,
a controller in communication with said display for sending data thereto pertaining to razor cartridge use, and
transfer means for transferring data from said memory means to said controller when at least a portion of said wet shave razor is received by said base unit.

2. The shaving system of claim 1, wherein said razor cartridge is releasably coupleable to said handle and said wet shave razor further comprises a release switch assembly in communication with said razor cartridge, said release switch assembly being in communication with said control module so that said control module records the replacement of said razor cartridge.

3. The shaving system of claim 2, wherein said release switch assembly includes a magnet and said control module includes a reed switch actuatable via said magnet to indicate at least one of the removal and replacement of said razor cartridge.

4. The shaving system of claim 1, wherein said control module comprises, a tilt switch for sensing a position of said wet shave razor and for generating and conveying signals to said control module.

5. The shaving system of claim 4, wherein said signals conveyed to said control module are indicative of the vertical orientation of said wet shave razor.

6. The shaving system of claim 1, wherein said control module comprises a microcontroller.

7. The shaving system of claim 6, wherein said microcontroller is powered by a capacitance device located in said handle and charged by a transformer when said wet shave razor is removably positioned in said base unit, said transformer being housed in said base unit and electrically coupled to a power source.

8. The shaving system of claim 1, wherein said control module includes a rechargeable power supply and said base unit and said wet shave razor cooperate to form an inductive link when said wet shave razor is removably positioned in said base unit, said inductive link forming part of said transfer means and being operable charge said control module power supply.

9. The shaving system of claim 1, wherein said control module is potted in a waterproof compound.

10. The shaving system of claim 1, wherein said control module is operable to count shaving strokes.

11. The shaving system of claim 1, wherein said control unit transmits information indicative of the number of strokes detected to said display which provides an indication of remaining useful razor cartridge life.

12. The shaving system of claim 11, wherein in addition to providing an indication of remaining useful cartridge life, said control module and said display also cooperate to function as a clock.

13. A shaving system including an integrated shave counter and base unit, said shaving system comprising:
a wet shave razor including sensing means for detecting and monitoring movement of said wet shave razor;
processing means for receiving information from said sensing means and for generating signals indicative of said movement of said wet shave razor; and
means for displaying information in response to said signals received from said processing means indicative of a useful life of a razor cartridge coupled to said wet shave razor.

14. The shaving system of claim 13, wherein said sensing means includes a controller in communication with a level switch.

15. The shaving system of claim 14, wherein said controller communicates with a resettable switch actuatable by at least one of the removal from and insertion on said wet shave razor of a razor cartridge.

16. The shaving system of claim 13, wherein said wet shave razor is integrated with said means for displaying the value indicative of the number of strokes via an inductive coupling link.

17. The shaving system of claim 13, wherein said means for detecting and monitoring the movement of said wet shave razor is a software algorithm.

18. The shaving system of claim 17, wherein said software algorithm increments a number of shaving strokes based on movements of said wet shave razor.

19. A method of tracking the use of a shaving device, comprising the steps of:
receiving an input signal indicative of a movement of said shaving device;
maintaining a count of a number of said input signals;
incrementing said count of said number of input signals in response to received input signals; and
displaying a value in response to the counted number of input signals.

20. The method of claim 19, further comprising correlating said counted number of input signals to a value indicative of the number of shaving strokes.

21. The method of claim 19, further comprising generating said input signal via a tilt switch.

22. The method of claim 19, further comprising resetting the counted number of input signals via a magnetically actuatable switch.

23. The method of claim 19, further comprising displaying a time value.

24. The method of claim 19, further comprising powering said shaving device via an inductive coupling link.

25. The method of claim 24, wherein said inductive coupling link is maintained between said shaving device and an integrated base unit.
